(19) United States
(12) Patent Application Publication
(10) Pub. No.: US 2011/0265090 A1
(43) Pub. Date: Oct. 27, 2011

(54) MULTIPLE CORE DATA PROCESSOR WITH USAGE MONITORING

(76) Inventors: WILLIAM C. MOYER, Dripping Springs, TX (US); Ravindraraj Ramaraju, Round Rock, TX (US); David R. Bearden, Austin, TX (US)

(21) Appl. No.: 12/765,534

(22) Filed: Apr. 22, 2010

(51) Int. Cl. G06F 9/46; G06F 17/30

(52) U.S. Cl. 718/103; 707/812; 718/102; 707/E17.005

(57) ABSTRACT

A data processor with a plurality of processor cores. Accumulated usage information of each of the plurality of processor cores is stored in a storage device within the data processor, wherein the accumulated usage information is indicative of accumulated usage of each processor core of the plurality of processor cores. Accumulated usage information for a core of the plurality of processor cores is updated in response to a determined use of the core.

### BACKGROUND OF THE INVENTION

1. Field of the Invention

This invention relates to multi core data processors and more specifically to usage monitoring in multi core data processors.

2. Description of the Related Art

Multi core data processors are data processors that include two or more processor cores. Because data processors are implemented on integrated circuits, the cores of a processor have a finite operating life based on the number of operations performed. As the accumulated number of operations performed increases, the integrated circuit may be more readily susceptible to dielectric breakdown, electro migration, and Negative Bias Temperature Instability. Furthermore, the temperature, operating frequency, and operating voltage under which a processor operation is performed may affect the longevity of the data processor. Typically, the higher the average operating temperature and/or operating voltage, the shorter the longevity (useful life) of the processor.

Some system manufactures who implement data processors may have longevity requirements where a data processor should be able to cumulatively operate at a particular operating condition (e.g. at a particular temperature, voltage, frequency range) for a particular number of hours.

What is needed is an improved system for allowing flexible use of a data processor.

### BRIEF DESCRIPTION OF THE DRAWINGS

The present invention may be better understood, and its numerous objects, features, and advantages made apparent to those skilled in the art by referencing the accompanying drawings.

FIG. 1 is a block diagram of a data processing system according to one embodiment of the present invention.

FIG. 2 is a table of data stored in a data processing system according to one embodiment of the present invention.

FIG. 3 is a table of data stored in a data processing system according to one embodiment of the present invention.

FIG. 4 is a flow chart of an operation of a data processor according to one embodiment of the present invention.

FIG. 5 is a table of data stored in a data processing system according to one embodiment of the present invention.

FIG. 6 is a flow chart of an operation of a data processor according to one embodiment of the present invention.

FIG. 7 is a flow chart of an operation of a data processor according to one embodiment of the present invention.

FIG. 8 is a flow chart of an operation of a data processor according to one embodiment of the present invention.

The use of the same reference symbols in different drawings indicates identical items unless otherwise noted. The Figures are not necessarily drawn to scale.

### DETAILED DESCRIPTION

The following sets forth a detailed description of a mode for carrying out the invention. The description is intended to be illustrative of the invention and should not be taken to be limiting.

Embodiments described relate to a multi core data processor that monitors and tracks the accumulated usage of each core. In some examples, the usage can be tracked at different operating conditions such as at different operating voltages, temperatures, operating frequencies, and at different thermal cycling conditions. In other embodiments, the measure of usage can be altered by operating conditions that affect the operating life of the integrated circuit. In one example, the accumulated usage of each core can be used in assigning data processor operations to the cores so as to balance core usage. It can also be used to alert a system user when the end of life of a part is near.

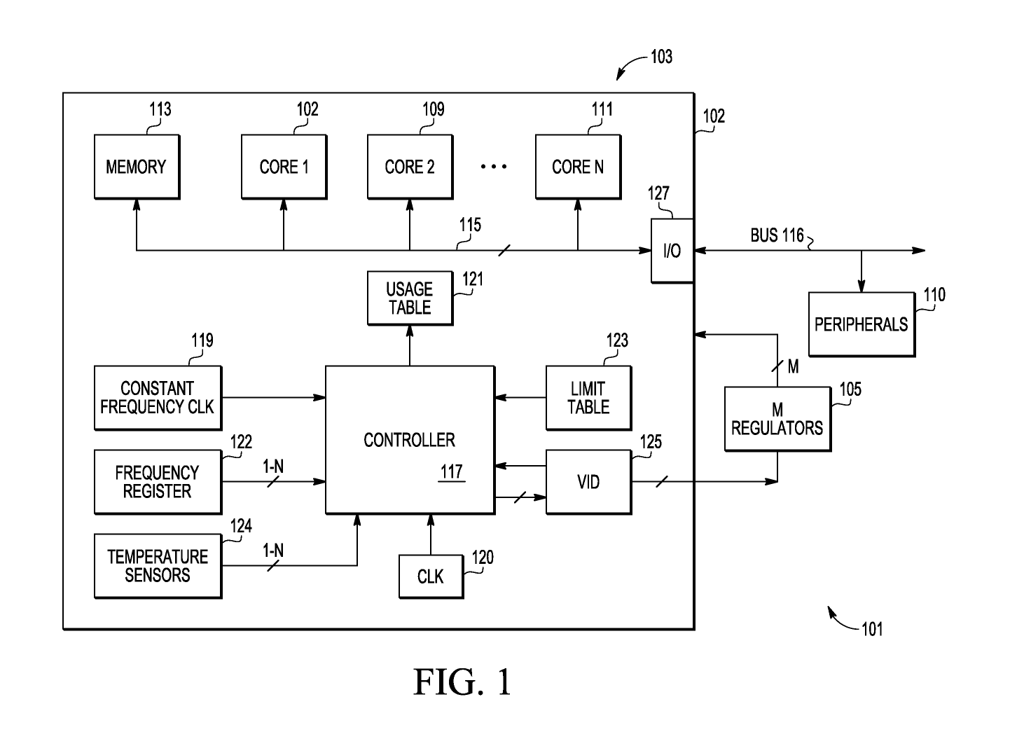

FIG. 1 is a block diagram of a data processing system 101. Data processing system 101 includes a multi core data processor 103, which in one embodiment is implemented in an integrated circuit 102. In other embodiments, data processor 103 may be implemented in multiple integrated circuits. In the embodiment shown, processor 103 is a multi core data processor that includes processor cores 107, 109, and 111, but may include a different number of processor cores in other embodiments. A processor core includes an execution unit for performing processing operations as per executable code. Each core of processor 103 is of a particular data processing architecture type such as e.g. Power PC, x86, SPARC, MIPS, or ARM architecture. Each core also is of a particular processor configuration such as e.g. a general purpose processor, a digital signal processor, an applications specific processor, or a network packet inspection processor. In one embodiment, the cores have identical configurations and architectures, but in other embodiments, the cores have different configurations and architectures from each other. For example, one of the cores may be a digital signal processor and the other cores may be general purpose processors of a different architecture.

Processor 103 includes a system memory 113 that is operably coupled to the cores via a processor bus 115 (or other type of system interconnect in other embodiments). Processor 103 also includes I/O circuitry 127 coupled to bus 115 for coupling data processor 103 to peripheral devices 110 of data processing system 101 via a peripheral bus 116. Examples of peripheral devices 110 include a memory (e.g. hard disk drive, RAM, ROM, Flash), key board, mouse, speaker, microphone, display, and bridge. In one embodiment, at least some devices or a portion some devices may be located on the same integrated circuit 102 as processor 103.

Processor 103 includes a clock circuit 120 for providing clock signals to the circuitry of processor 103 including to cores 107, 109, and 111, and memory 113. In one embodiment, clock circuit 120 provides an independently controllable clock signal to each processor core to control the operating frequency of that core (the clock signal lines to each core are not shown in FIG. 1). Processor 103 may have other configurations in other embodiments including other circuits such as e.g. a cache (not shown).

System 101 also includes multiple voltage regulators 105 for providing regulated operating voltages to circuitry of data processor 103 including to the cores 107, 109, 111, and memory 113. The voltages provided by the regulators are controlled by VID values from VID registers 125. In one embodiment, each processor core receives a separate regulated voltage that is independently controlled by a separate VID value to enable the operating voltage of each core to be individually adjusted. In other embodiments, the operating voltage to multiple cores can be controlled by one VID value.

In the embodiment shown, processor includes a controller 117 for controlling the assignment of processor operations to each core. A processor operation is an operation performed by one or more processors executing a set of instructions. In the embodiment shown, controller 117 is implemented by circuitry separate from cores 107, 109, and 111. However, in some embodiments, at least portions of controller 117 maybe implemented by a software program running on one of cores 107, 109, and 111. Controller 117 evaluates the programs being run on data processor 103 and assigns the operations of those programs to be performed by a particular core or cores. In one embodiment, processes or threads of execution may be assigned by the operating system or other software to one or more specific cores. In addition, hardware multithreading or multiprocessing control may be implemented within controller 117 which directs the execution of different sets of operations to one or more selected processors.

In the embodiment shown, controller 117 also monitors the accumulated usage of each core over the lifetime of integrated circuit 102. The accumulated usage of a core refers to a cumulative amount of usage of the core during its lifetime. In one embodiment, the accumulated usage is measured in terms of time in performing operations, but it other embodiments, it may be measured with respect to other parameters such as the number of tasks performed or the number of instructions executed by the core.

Processor 103 includes a usage table 121 that stores the accumulated usage information for each core. In one embodiment, table 121 is implemented in a non volatile memory on integrated circuit 102 (“on chip”). However, table 121 may be implemented in other ways in other embodiments. For example, the usage information could be stored in on-chip RAM during the operation of system 101 and down loaded to an off-chip non volatile memory (e.g. hard disk drive, battery-backed RAM, flash memory, etc.) when the processor is not being used.

In the embodiment shown, processor 103 includes a constant frequency clock generator 119 for providing a constant frequency clock signal to controller 117 that controller 117 uses to calculate time to add to the accumulated usage information of each core. In one embodiment, controller 117 determines that the core is being used by determining that the core's clock is running, by interrogating a status indicator, or by determining that the core is in one or more active states of operation (e.g. by reading a particular register associated with the core). In one embodiment, controller 117 measures the time that it's being used by the clock signal from clock generator 119. That amount of time is then added to the accumulated usage information for that core stored in usage table 121. In one embodiment, generator 119 may include an input coupled to an off-chip crystal (not shown), but other techniques for generating a constant frequency clock signal may be used in other embodiments. Also in other embodiments, a different method of calculating elapsed time may be employed by controller 117 to determine usage time. In some embodiments, a real time clock provided from off-chip can be used to measure the total elapsed time as function of wall clock time.

In the embodiment shown, processor 103 includes a limit table 123 for storing the lifetime limits of the processor core. A lifetime limit is the total amount of usage that a core is expected to reliably perform during its lifetime. In one embodiment, limit table 123 is stored in an on chip non volatile memory but may be implemented in other ways in other embodiments. For example, the lifetime limits may be provided by programmable logic or a hardware logic table, or may be stored in an off chip memory.

In one embodiment, controller 117 uses the accumulated usage information for each core in assigning the processor operations to each core. In one embodiment, controller 117 assigns the processor operations to the cores with the least amount of accumulated usage time in order to balance the usage times among the cores.

In one embodiment, controller 117 includes the ability to adjust the accumulated usage value or record separate usage values for a core operating at specific operating conditions. Due to various factors, operating at an elevated higher operating frequency, temperature, or operating voltage for a particular time reduces the useful life of a core by a greater amount than when operating at a relatively lower operating frequency, temperature, or operating voltage. Accordingly, in the embodiment shown, data processor 103 includes circuitry and systems for determining the operating condition of a core for a use of a core. For example, processor 103 includes frequency registers 122 for providing the operating frequency of each core. In one embodiment, the operating frequency of each core is written to registers 122 by the operating system of data processor 103. In one embodiment, clock circuit 120 uses the information in registers 122 in providing the clock signals to each core. Processor 103 includes temperature sensors 124 for providing an indication of the operating temperature of each core. In one embodiment, each core includes its own temperature sensor, however in other embodiments, one temperature sensor could be used to provide an indication for the temperature of each core or at least some of the cores. In the embodiment shown, controller 117 provides the VID values to register 125 to control the operating voltage for each core. However, in other embodiments, other circuitry may control the operating voltages where controller 117 would receive an indication of the VID values (which indicate operating voltage) from register 125. The operation condition of the cores may be determined by other ways in other embodiments.

In the embodiment shown, the usage monitoring of each core is performed by controller 117. In some embodiments, controller 117 may include a usage monitor module (not shown) for monitoring individual core usage and a separate assignment module (not shown) for assigning processor operations to the cores. These modules may be implemented in different circuitry and/or with different code. In such embodiments, the assignment module may utilize the accumulated usage information generated by the usage monitor module in distributing processor operations to the different cores.

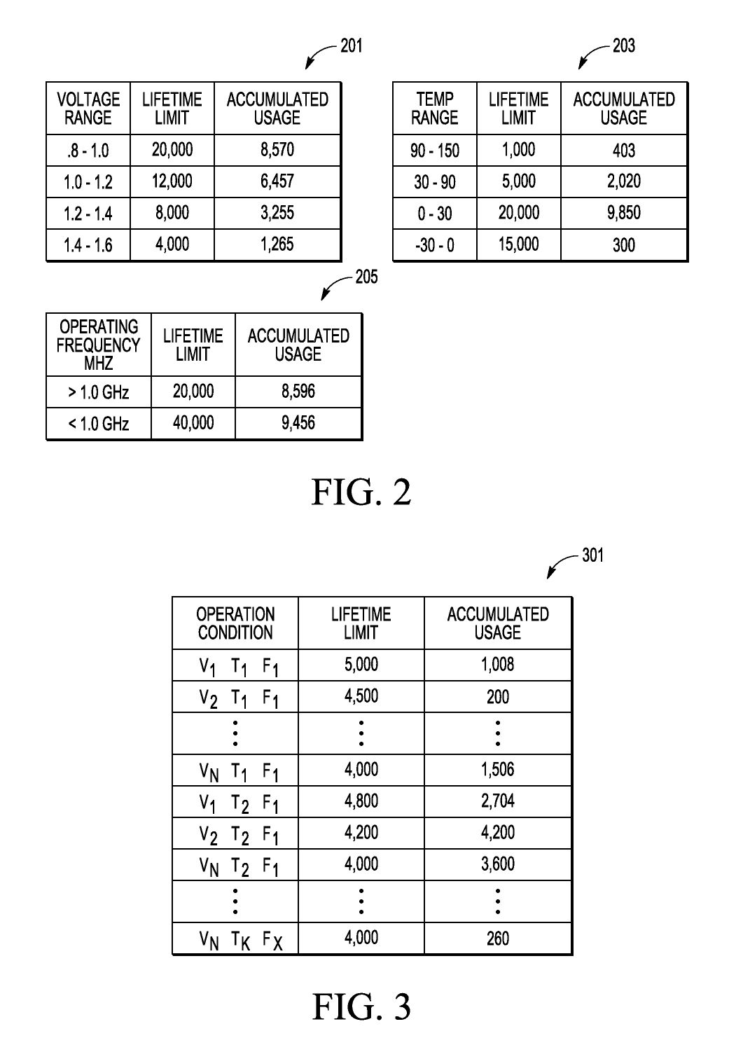

FIG. 2 illustrates the types of accumulated usage information that may be stored in usage table 121 in one embodiment of the present invention. Table 201 shows, for a particular core, the accumulated usage information (under the heading “accumulated usage”) for each operating voltage range. The values in the accumulated usage column represent the amount of time (in hours in one embodiment) that a core has operated with an operating voltage at that specified voltage range. For example, the particular core associated with the values shown in table 201 has operated with an operating voltage in the range of 0.8-1.0 volts for 8570 hours. The core has operated with an operating voltage in the range of 1.0 to 1.2 volts for 6,457 hours The core has operated with an operating voltage in the range of 1.2 to 1.4 volts for 3,255 hours. The core has operated with an operating voltage in the range of 1.4-1.6 volts for 1265 hours. Accordingly with table 201, controller 117 can track the amount of time that a core operates with an operating voltage in a particular voltage range. In other embodiments, accumulated usage may be recorded in other units of time e.g. such as minutes, seconds or a number of constant frequency clock cycles.

Table 203 records the amount of time (under the heading “accumulated usage”) that a core operates at a particular temperature range (in Celsius) and table 205 records the amount of time that a core operates at a particular operating frequency range. In one embodiment, usage table 121 would include three such tables for each core. However, in other embodiments, usage information for a lesser or greater number of operating condition parameters may be monitored. For example, in one embodiment, a count of excessive thermal temperature cycles (a sudden change in operating temperature) that a core has been subject to may be stored.

In the embodiment of FIG. 2, each table (201, 203, and 205) includes a “Lifetime Limit” column that represents the expected amount of reliable operation of the core at that particular operating condition over the lifetime of the data processor.

For example, in table 201, the core is expected to be able to operate for 20,000 hours with an operating voltage in the range of 0.8-1.0 volts.

Because of the stress of operating at higher operating frequencies, temperatures, and/or operating voltages, the lifetime limits as shown in FIG. 2 for the higher operating frequencies, temperatures, and operating voltages is less than for the lower values of these parameters. In the embodiment of FIG. 1, the lifetime limit information is store in table 123, however, in other embodiments, the accumulated usage and lifetime limit information may be stored in the same memory. The values given in tables 201, 203, and 205 are exemplary values for a particular core of a data processor according to one embodiment. The tables of other embodiments may include other values for accumulated usage and lifetime limit.

In one embodiment, controller 117 uses the data in tables 201, 203, and 205 for each core to assign processor operations to a particular core. For example, if a particular processor operation requires operating at a particular operating frequency (e.g. above 1 GHz), controller 117 may look for the processor core with the lowest amount of accumulated usage time at that particular operating frequency range and assign the processor operation to that core.

In other embodiments, it may be desirable for a particular core of a data processor to perform a particular processor operation. In one example, one core of a multi core processor may be identified as having the fastest performance. Prior to assigning a processor operation to that core, controller 117 would examine the accumulated usage column of that core at the particular desired operating frequency or voltage and determine whether that particular core has exceeded its lifetime of operation for that operating condition. If the lifetime limit has been exceeded, controller 117 would assign another core the processor operation.

In other embodiments, the accumulated usage may be one factor in assigning cores. For example, controller 117 may assign multiple cores to perform a processor operation based on both the lowest accumulated usage and thermal balancing of the cores on the integrated circuit. In one such example, the cores may be arranged in such a way that particular combinations of cores provide the lowest thermal output to avoid hot spots on the integrated circuit. The combination selected to perform the processor operation may be the combination with the lowest total accumulated usage, the combination having the core with the lowest accumulated usage, or the combination with the lowest value for the highest accumulated usage core of the combination.

In other embodiments, controller 117 may lower the operating voltage or reduce the operating frequency of a core (by providing a control signal to clock circuit 120) if the accumulated usage value at the desired operating voltage or frequency is over the lifetime limit. For example, if the desired operating voltage for a particular processor operation is 1.5 volts, but the accumulated usage value has exceed the lifetime limit at that range, controller 117 may drop the operating voltage (by adjusting the VID value) to a lower voltage. Also, if the temperature is at a range where the life time limit has been exceeded, then controller 117 may drop the operating voltage and/or frequency to reduce the operating temperature.

FIG. 3 shows another embodiment of a usage table according to the present invention. In the embodiment shown, each entry of table 301 represents an operating condition that is defined by three parameters (operating voltage (V), operating temperature (T), and operating Frequency (F). The entries in the operating condition table of “V1,” “V2”, and “VN” represent different operating voltage ranges, the entries “T1”, “T2,” and “TK” represent different operating temperature ranges, and the entries “F1” and “FX” represent different operating frequency ranges. Accordingly, each entry of the table is defined by a particular operating voltage range, a particular operating frequency range, and a particular temperature range. Each monitored combination of operating voltage range, operating frequency range, and temperature range has an entry in the table. The usage time and lifetime limit is recorded for each operating condition entry. A table similar to table 301 would be recorded for each core of data processor 103. In other embodiments, the operating conditions maybe defined by a greater or lesser number of operating condition parameters.

In one embodiment, controller 117 uses each table to assign processor operations among the cores to balance the accumulated usage totals for each core at a particular operating condition. Also, the operating condition of a processor core for performing processor operations may be adjusted based on the accumulated usage value verses the Lifetime Limit.

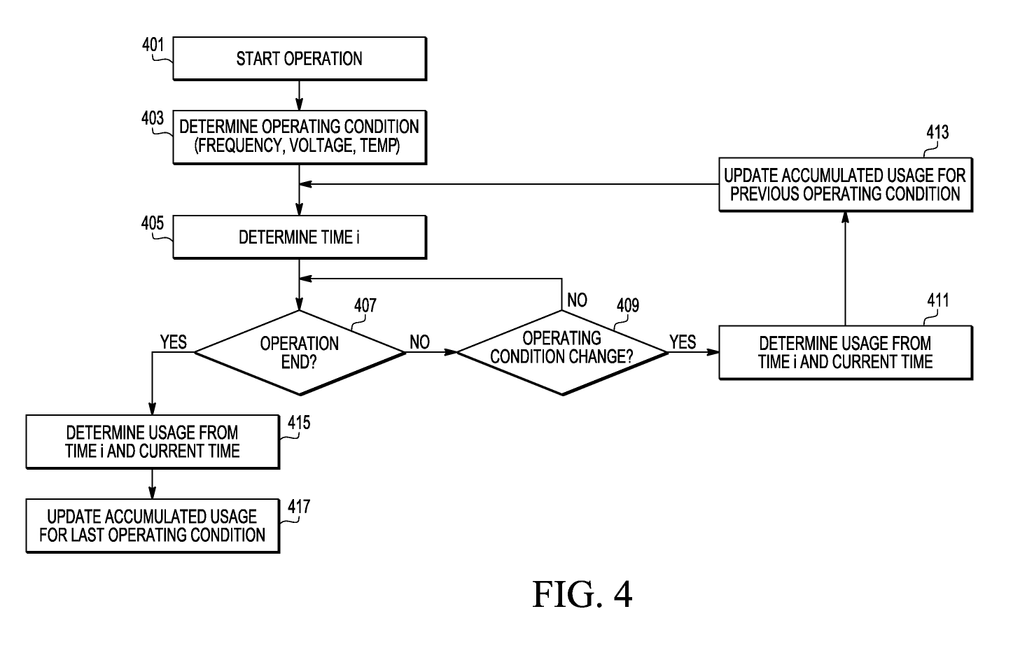

FIG. 4 shows a flow chart of an operation of a controller 117 in monitoring the accumulated usage of a core according to one embodiment of the present invention. The method is started at the start 401 of a processor operation by a processor core In 403, the operating condition of the core is determined (e.g. measurements are made of the operating frequency, operating voltage, and temperature) and in operation 405, the time (time i) is determined at the start of the processor operation from the clock signal provided by the constant frequency clock generator 119. In decision block 407, a determination is made whether the processor operation has been completed by the core. If so, in operation 415 a usage time is determined by subtracting the current time (as indicated by the clock signal from clock generator circuit 119 at the end of the processor operation) from the time (time i) determined in operation 405. In operation 417, the accumulated usage value for the core for the particular operating condition measured in 403 is updated to reflect the usage time for the processor operation.

If in 407, the processor operation has not ended and the operating condition changes (e.g. a change in temperature, operating voltage, or operating frequency) as determined in decision block 409, then in 411, a usage time is determined by subtracting the time (time i) determined in operation 405 from the current time (the time at the change of the operating condition) as determined by the clock signal from clock generator 119. In 413, that usage time is added to the accumulated usage time for the operating condition determined in operation 403. After 413, the process flows back to operation 405 where the current time determined in 411 becomes time i. The process continues to monitor the core until the processor operation is finished or the operating condition changes for a second time. At which time, the accumulated usage for the operating condition resulting from the first change in operating condition is updated with the usage time since the first occurrence of 411. Thus, with the process in FIG. 4, usage time is tracked for a particular set of operating conditions.

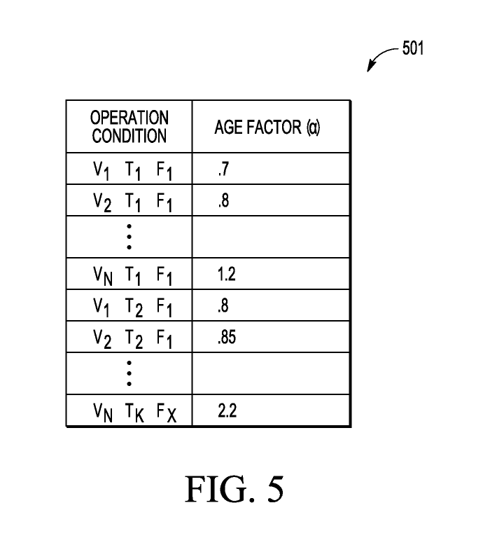

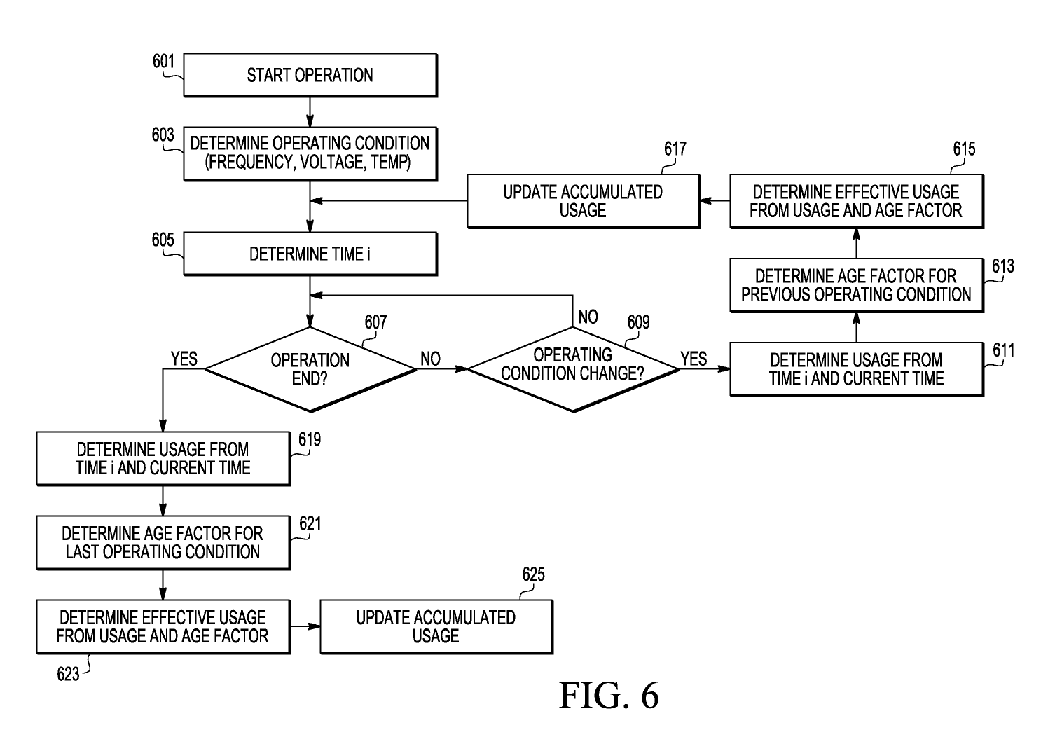

FIGS. 5 and 6 set forth a table and flow diagram respectively, for another embodiment for using monitored operating conditions in the tracking of accumulated usage of a processor core. In this embodiment, only one value for accumulated usage is stored for each core. The time for performing a processor operation by a core that is recorded for the accumulated usage time is altered or adjusted based on the measured operating condition during that time to reflect the severity of the operating condition at that time. For example, if a processor core operates for 5 hours at 70 degrees C., it is more detrimental to the operating life of the core than operating at 5 hours at 25 degrees C. Accordingly, with this embodiment, the measured operating time is increased to reflect the increased severity of the operating condition.

FIG. 5 shows a table listing an age factor associated with a particular operating condition that is defined by a particular voltage range (V), temperature range (T), and frequency range (F). The values V1, V2, and VN represent different operating voltage ranges, the values T1, T2, and TK represent different temperature ranges, the values F1 and FX represent different operating frequency ranges. The age factor value for that operating condition reflects the severity of that operating condition on an integrated circuit operation. For example, operating in operating conditions with relatively high temperature ranges (e.g. 50 C and higher) will more quickly reduce the operating life of an integrated circuit than when operating at lower temperatures. According, the age factor for operating conditions with higher temperature ranges are higher (e.g. above 1.0) than for operating conditions with lower temperature ranges. In one embodiment, table 501 is stored in usage table 121, however, other embodiments may store the information using other mechanisms.

FIG. 6 shows one embodiment of how controller 117 uses the age factor of a measured operating condition to update the accumulated usage for a core. In 601, a processor operation is started by a core. In 603, the operating condition (e.g. operating frequency, operating voltage, and operating temperature) of the core is determined and in 605, a time (time i) based on clock generator 119 is determined at the start of the processor operation. At decision block 607, a determination is made as to whether the processor operation is completed. If it has completed, in 619, the usage time is determined by subtracting time i (determined at 605) from the current time (the time when the processor operation is completed). At 621, an age factor is retrieved from the table based on the operating condition determined in 603. In 623, the usage time is multiplied by the age factor to derive an effective usage time. The accumulated usage time for that core is then updated with the effective usage time at 625.

If the processor operation has not ended in 607, then in response to a change in operating condition (e.g. temperature, operating voltage, or operating frequency) in decision 611, a usage time is determined from subtracting the time (time i) determined in 605 from the current time (the time that the operating condition changes). In 613, the age factor corresponding to the operating condition determined in 603 is multiplied by the usage time determined in 611 to derive an effective usage in 615. In 617, the accumulated usage for the core is updated with the effective use. In the second occurrence of 605, time i becomes the time at the change in operating condition (as determined in 611). The process continues until the operating condition changes as determined in 609 or the processor operation is complete (as determined in 607). The usage time is then calculated from the time at operation 613 to the time that the processor operation stops or the operating condition changes. The age factor is determined from the operating condition during that time and is used to adjust the usage time.

In other embodiments, an age factor may be implemented in other ways. For example, each operating condition parameter (e.g. temperature, operating voltage, and operating frequency) may have its own age factor, in which all three age factors would be used to determine effective usage time. In one such example, each age factor would be multiplied by the measured time. In one example of such an embodiment, each age factor would be obtained from a separate table and would correspond to a range of the measured corresponding operating condition parameter. In another embodiment, the age factor would be obtained from a formula using the measured operating condition value as the dependent variable in the formula and the age factor as the independent variable. In some embodiments, the total age factor may be reflective of a lesser number (e.g. 2 or 1) parameters e.g. just temperature.

In other embodiments, other operating condition parameters may monitored and used to adjust or calculate an accumulated usage. For example, the accumulated usage may be measured or adjusted for excessive thermal cycling of the core. Excessive thermal cycling is where the operating temperature changes by at least a predetermined amount during a predetermined period of time. If excessive thermal cycling is determined to occur during a period of time, that time can be recorded in a table. In some embodiments, the usage time representing the time during a processor operation that includes the thermal cycling is increased to reflect the occurrence of the excessive thermal cycle. In some embodiments, a predetermined time may be added to the accumulated usage upon the detection of an excessive thermal cycling event.

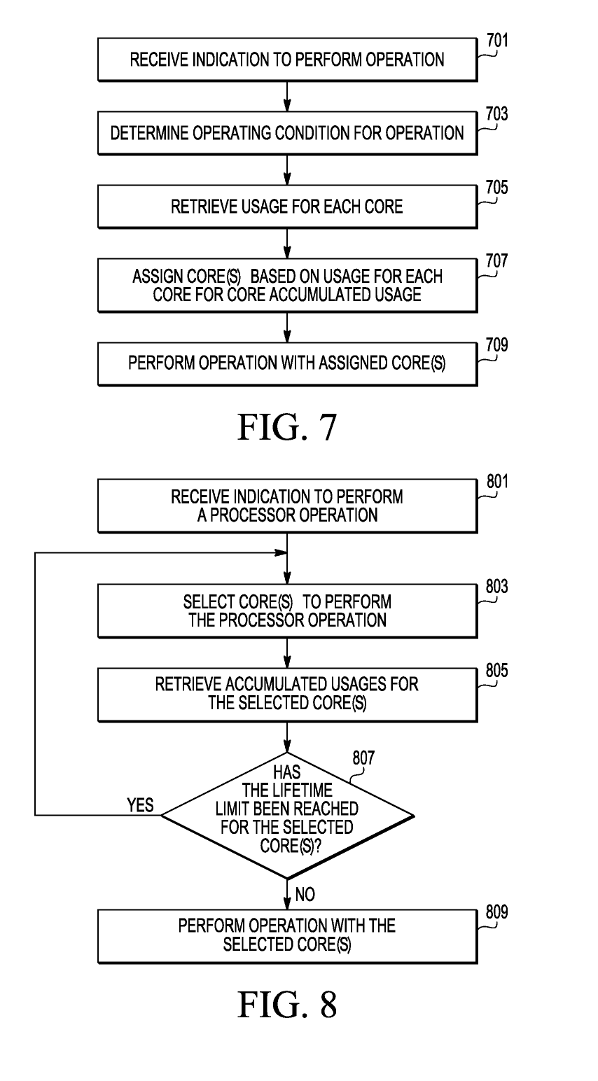

FIG. 7 sets forth a flow diagram showing the operation of controller 117 in using the accumulated usage information from each of the cores to assign processor tasks to a core or cores according to one embodiment of the present invention. In 701, controller 117 receives an indication of a processor operation to be performed. In one embodiment, this indication is provided by the operating system or other software monitor, or in other embodiments by an interrupt indicating the need for processing of information. In 703, controller determines the desired operating condition (e.g. operating frequency and operating voltage) for the processor operation. In one embodiment, the desired operating condition is based on the relative priority of the operation, or other measures of processing power required or desired to be used. In 705, the accumulated usage values for each core are obtained. In one embodiment, the usage values for the desire operating conditions are obtained (e.g. as in the embodiment of FIG. 3), whereas in the embodiment of FIGS. 5 and 6, the total accumulated usage values for each core are obtained. In 707, the core or cores are assigned to perform the processor operations based on the accumulated usage of each core to balance the accumulated usages among the cores. In 709, the processor operation is performed with the assigned cores.

FIG. 8 shows the operations of controller 117 in determining which cores to use to perform a processor operation according to another embodiment of the present invention. In this embodiment, other factors may be used to select a core or cores to perform a processor operation in addition to the accumulated usage of the cores. In addition, as described earlier, it may not be desirable to balance accumulated usage of the cores, and other selected metrics using the accumulated usage information for one or more cores may be used in determining which core(s) are used to perform the processor operation.

In operation 801, controller 117 receives an indication to perform a processor operation. In 803, controller 117 selects a core or cores to perform the operation. In one embodiment, the selection in 803 is based on factors such as whether the core has been previously determined to be the most efficient or the fastest, or operates at the lowest temperature based on process variation during manufacture. In 805, controller 117 retrieves the accumulated usage values for the selected core or cores. In 807, if the accumulated usage has exceeded the lifetime limit for a selected core, then another core is chosen and its accumulated usage is evaluated to determine if it has reached its life time limit. If not, then the selected core performs the task in 809.

In some embodiments, if the accumulated usage of a core exceeds the lifetime limit, the system may be alerted that the processor core may in danger of failure. Also, the accumulated usage data may be used for other purposes, such as fault analysis of a part. Determining an allocated usage at different operating conditions for a core may enable an integrated circuit manufacturer to more accurately determine the cause of failure of a core.

In other embodiments, multiple “life time limit” values for each operating condition may be given for a core which each value having a different threshold. In some embodiments, in response to the accumulated usage value of a core reaching one of the lower threshold levels, controller 117 would reduce the operating voltage and/or frequency of any processor operations performed by the core. Thus, as the part ages and nears the end of its life, operating voltages and frequencies can be reduced to extend core life.

Also, in some embodiments, age factors according to some operating condition parameters may be used to adjust the accumulated usage values that are stored in a table corresponding to ranges of other operating condition values.

Providing a multi core processor that monitors accumulated usage of its cores may provide for a data processor that balances the work performed by each of the cores to extend the life of the integrated circuit which incorporates the multi core data processor. By balancing the loads, the chance of a premature failure of one of the cores is reduced. If load balance is not utilized, then the life time of a data processor is limited to the lifetime of any of the cores. Whereas with load balancing, the rated life of the data processor can be a greater than the rated lifetime of any one core.

Furthermore, by accounting for the severity of the operating conditions of a core during the performance of a processor operation, a more accurate estimate of the reduction of useful life of a core by the processor operation can be determined.

In one embodiment in a data processor including a plurality of processor cores, a method includes storing accumulated usage information for each of the plurality of processor cores in a storage device. The accumulated usage information for a processor core of the plurality of processor cores is indicative of accumulated usage of the processor core. The method also includes updating by the data processor accumulated usage information for a core of the plurality of processor cores in response to the data processor determining a use of the core.

In another embodiment, a data processor includes a plurality of processor cores for performing data processing operations and a storage device for storing accumulated usage information for each of the plurality of processor cores that is indicative of accumulated usage of the each of the plurality of processor cores. The data processor also includes a controller for determining usage of the plurality of processor cores. The controller updates accumulated usage information of a processor core of the plurality of processor cores in response to determining a use of the processor core.

In another embodiment in a multi core data processor, a method includes receiving an indication to perform a data processing operation and selecting at least one selected processor core of a plurality of cores of the data processor to perform the data processing operation. The selecting includes using accumulated usage information of at least one of the plurality of cores. Accumulated usage information of a processor core is indicative of accumulated usage of the processor core. The method includes performing the data processing operation by the at least one selected processor core.

While particular embodiments of the present invention have been shown and described, it will be recognized to those skilled in the art that, based upon the teachings herein, further changes and modifications may be made without departing from this invention and its broader aspects, and thus, the appended claims are to encompass within their scope all such changes and modifications as are within the true spirit and scope of this invention.

What is claimed is:

1. In a data processor including a plurality of processor cores, a method comprising:
storing accumulated usage information for each of the plurality of processor cores in a storage device, wherein the accumulated usage information for a processor core of the plurality of processor cores is indicative of accumulated usage of the processor core;
updating by the data processor accumulated usage information for a core of the plurality of processor cores in response to the data processor determining a use of the core.

2. The method of claim 1 wherein the storing the accumulated usage information further comprises:
storing a plurality of accumulated usage values for each core of the plurality of processor cores, wherein each of the plurality of accumulated usage values for the each core correspond to an operating condition defined by at least one operating condition parameter.

3. The method of claim 1 further comprising:
monitoring at least one of a group consisting of temperature of operation, operating voltage, operating frequency, and thermal cycling for the use of the core and providing an indication of a result of the monitoring; and
wherein the updating accumulated usage information for a core includes using the indication in performing the updating.

4. The method of claim 1 further comprising:
in response to determining differing accumulated usages for at least two of the plurality of processor cores, assigning tasks for execution by the plurality of processor cores on a prioritized basis wherein tasks are assigned based on which processor core has a lowest accumulated usage value.

5. The method of claim 1 further comprising:
assigning a task to a predetermined one of the plurality of processor cores to the exclusion of other cores of the plurality of processor cores; and
in response to determining an accumulated usage of the predetermined one of the plurality of processor cores has passed a predetermined threshold, removing the predetermined one of the plurality of processor cores from the task and using an other of the plurality of processor cores to perform the task.

6. The method of claim 1 further comprising:
assigning tasks to predetermined ones of the plurality of processor cores to the exclusion of others; and
in response to determining an accumulated usage of any of the predetermined ones of the plurality of processor cores has passed a predetermined threshold, modifying an operating condition parameter of the any of the predetermined ones of the plurality of processor cores in performing the tasks.

7. The method of claim 1 wherein said updating the accumulated usage information further comprises:
determining an age factor of the core based upon an operating condition of the core during the use, the operating condition defined by at least one operating condition parameter; and
using the age factor to adjust an amount that the accumulated usage information is updated.

8. The method of claim 1 wherein said updating the accumulated usage information further comprises:
updating an accumulated usage value of a plurality of stored accumulated usage values for the core, wherein each value of the plurality of stored accumulated usage values corresponds to a particular operating condition of a plurality of operating conditions of the core defined by at least one operating condition parameter, wherein the particular operating condition corresponds to an operating condition of the core during the use of the core.

9. A data processor comprising:
a plurality of processor cores for performing data processing operations;
a storage device for storing accumulated usage information for each of the plurality of processor cores that is indicative of accumulated usage of the each of the plurality of processor cores; and
a controller for determining usage of the plurality of processor cores, wherein the controller updates accumulated usage information of a processor core of the plurality of processor cores in response to determining a use of the processor core.

10. The data processor of claim 9 further comprising:
at least one temperature sensor for providing at least one indication of temperature of the plurality of processor cores;
at least one frequency register for storing at least one value indicative of operating frequencies of the plurality of processor cores; and
at least one voltage register for providing at least one value indicative of operating voltages of the plurality of processor cores;
wherein the controller uses for updating accumulated usage information, at least one of the group consisting of the at least one indication of temperature, the at least one value indicative of operating frequencies, and the at least one value indicative of operating voltages.

11. The data processor of claim 9 wherein the storage device stores a plurality of accumulated usage values for the each core of the plurality of processor cores, wherein each of the plurality of accumulated usage values corresponds to an operating condition defined by at least one operating condition parameter.

12. The data processor of claim 9 wherein the controller, in response to determining differing accumulated usages for at least two of the plurality of processor cores, assigns tasks for execution by the plurality of processor cores on a prioritized basis, wherein tasks are assigned based on which processor has a lowest accumulated usage.

13. The data processor of claim 9 wherein the controller assigns tasks to predetermined ones of the plurality of processor cores to the exclusion of other cores of the plurality of processor cores, wherein when an accumulated usage of any of the predetermined ones has passed a predetermined threshold, the controller modifies an assigned task.

14. The data processor of claim 13 wherein the controller modifies an assigned task by removing the assigned task from a processor core having an accumulated usage which has passed a predetermined threshold and uses an other core of the plurality of processor cores to perform the assigned task.

15. The data processor of claim 9 wherein the controller determines age factors for uses of processor cores of the plurality of processor cores based upon operating conditions of the uses defined by at least one operating condition parameter, wherein the controller uses an age factor of a use of a processor core to adjust an amount that an accumulated usage information value of the processor core is updated to account for the use.

16. The data processor of claim 9 wherein the controller operates under software control to determine a use of a processor core.

17. In a multi core data processor, a method comprising:
receiving an indication to perform a data processing operation;
selecting at least one selected processor core of a plurality of cores of the data processor to perform the data processing operation, wherein the selecting includes using accumulated usage information of at least one of the plurality of cores, wherein accumulated usage information of a processor core is indicative of accumulated usage of the processor core; and
performing the data processing operation by the at least one selected processor core.

18. The method of claim 17 further comprising:
wherein the selecting includes not selecting cores having an allocated usage that exceeds a lifetime maximum allocated usage.

19. The method of claim 17 further comprising:
when a lifetime maximum allocated usage is determined to have been exceeded by a core of the at least one selected processor core, modifying the operation of the data processor to change an operating condition parameter of the at least one selected processor core.

20. The method of claim 17 wherein the selecting includes using accumulated usage information of the plurality of cores including the at least one selected processor core.
